(19) United States
(12) Patent Application Publication
(10) Pub. No.: US 2014/0199127 A1
(43) Pub. Date: Jul. 17, 2014

(54) CUTTING INSERT FOR FACE MILLING CUTTER AND INDEXABLE FACE MILLING CUTTER

(71) Applicant: MITSUBISHI MATERIALS CORPORATION, Tokyo (JP)

(72) Inventors: Yasuharu Imai, Joso-shi (JP); Hiroshi Hoki, Joso-shi (JP)

(73) Assignee: MITSUBISHI MATERIALS CORPORATION, Tokyo (JP)

(21) Appl. No.: 14/067,035

(22) Filed: Oct. 30, 2013

(30) Foreign Application Priority Data
Jan. 15, 2013 (JP) 2013-004785

(51) Int. Cl. B23C 5/20; B23C 5/06

(52) U.S. Cl. CPC B23C 5/207; B23C 5/06
USPC 407/42; 407/114

(57) ABSTRACT

The cutting insert for a face milling cutter is provided with an insert main body which is formed in a polygonal plate shape and in a shape of inversion symmetry on the front and back faces, a pair of polygonal faces facing in a thickness direction of the insert main body, side faces facing in a direction intersecting with the thickness direction, and cutting edges formed along a ridge line between the polygonal face and the side face. The polygonal face is in a substantially regular polygonal shape. The cutting edge has a major cutting edge, a minor cutting edge, and a connecting edge. The side face has a first flank face arranged adjacent to the cutting edge and gradually inclines outward in the insert radial direction. The first flank face is arranged so as to be adjacent at least to the major cutting edge.

### FIELD OF THE INVENTION

The present invention relates to a cutting insert for a face milling cutter and an indexable face milling cutter in which the cutting insert is used.

Priority is claimed on Japanese Patent Application No. 2013-004785 filed in Japan on Jan. 15, 2013, the content of which is incorporated herein by reference.

### DESCRIPTION OF THE RELATED ART

There has been known a conventional indexable face milling cutter which carries out a face milling operation for a workpiece made of a metal material or the like. The indexable face milling cutter is provided with a tool main body which is made of a steel material or the like and formed in a disk shape and a cutting insert for a face milling cutter which is made of a hard material such as a cemented carbide and attached in a detachable manner on each of insert seats which are formed in a plural number at an outer circumferential part of the end of the tool main body, with an interval kept in a circumferential direction.

A cutting insert for a face milling cutter includes, for example, that disclosed in Patent Document 1 given below is known. The cutting insert for a face milling cutter is provided with an insert main body which is in a shape of a square plate and formed in the shape of inversion symmetry on the front and back faces, a pair of square races which are configured to be a seating face facing in a thickness direction of the insert main body and is seated on the insert seat or a rake face facing opposite the insert seat (a direction at which the tool rotates), side faces which face in a direction intersecting with the thickness direction of the insert main body, and four cutting edges which constitute a ridge line between the square face and the side faces and are formed along the outer circumference of the square face. Further, each of the cutting edges is provided with a major cutting edge and a minor cutting edge which extends so as to form an obtuse angle with respect to the major cutting edge when the square face is seen in the front and which is configured to improve a finishing face of a workpiece. The major cutting edge extends so as to gradually incline toward a middle part of the side face of the insert along the thickness direction as being close to the opposite side of the minor cutting edge adjacent to the major cutting edge.

The above-described both-side type cutting insert for a face milling cutter is able to have a larger number of cutting edges due to the insert main body formed in the shape of inversion symmetry on the front and back faces and, consequently, made longer in tool life.

The shape of the insert main body is not limited to the above-described square plate. There is also known a cutting insert for a face milling cutter in which an insert main body is formed in a shape of a regular pentagonal plate or a regular hexagonal plate, for example, disclosed in Patent Document 2 given below.

[Patent Document 1] Published Japanese Unexamined Patent Application No. 2009-274207

[Patent Document 2] Published Japanese Translation No. 2001-502250

### SUMMARY OF THE INVENTION

In this type of the cutting insert for a face milling cutter, the tool main body is rotated around the tool axis, by which, of a pair of polygonal faces of the cutting insert, one cutting edge (one of the cutting edges) arranged at an outer circumferential part of the end of the tool on one polygonal face facing forward in a tool rotating direction is used for cutting. More specifically, a major cutting edge of the one cutting edge, which extends so as to incline with respect to the tool axis when the one polygonal face is seen in the front, cuts into a workpiece toward a tool radial direction, and a minor cutting edge which extends on a flat face perpendicular to the tool axis finishes (improves) a machined surface (finishing face) after the major cutting edge has cut.

In this case, when attention is given to the minor cutting edge of the one cutting edge, an outer portion (outer end portion) of the minor cutting edge in a tool radial direction along an edge length direction is cut at a higher speed than an inner portion (inner end portion) thereof in the tool radial direction. Therefore, the outer end portion is increased in cutting resistance. Thus, the minor cutting edge is cut into a workpiece, with the inner end portion kept ahead, by which the outer end portion can be decreased in cutting resistance and the cutting resistance acting on the minor cutting edge can also be dispersed in the edge length direction. Thus, effects of preventing edge fracture of the minor cutting edge can be provided.

More specifically, for example, as shown in FIG. 11 presented in Patent Document 1 given above, of one cutting edge used for cutting, a minor cutting edge (minor edge 14) is allowed to incline in the same direction as a major cutting edge (major edge 12) (in FIG. 11 of Patent Document 1, both the minor edge 14 and the major edge 12 incline downward on the right), thereby providing effects of preventing edge fracture of the above-described minor cutting edge.

However, in this case, there is inevitably found a great difference in height (a difference along the thickness direction of the insert main body) at a portion which connects the minor cutting edge to the major cutting edge of the other cutting edge (the cutting edge not used for cutting) positioned at the opposite side of the major cutting edge of the one cutting edge (the cutting edge used for cutting) adjacent to this minor cutting edge (a major cutting edge for removing chips which are not cut indicated by the reference numeral 28 in FIG. 11 of Patent Document 1 and a recessed portion positioned on the left side thereof), thereby making it difficult to conduct green compact press working, or the like. Further, in order to secure a great difference in height at the connection portion, the major cutting edge is inevitably required to decrease in edge length, which may affect cutting performance.

On the other hand, where the major cutting edge is set to decrease in inclination angle (an angle at which the major cutting edge inclines to a flat face perpendicular to the thickness direction of the insert main body) for the purpose of decreasing the difference in height at the connection portion, it is difficult to impart a sufficient positive angle to an axial rake angle of the major cutting edge on attachment of the cutting insert to the tool main body, thus resulting in a decrease in sharpness.

Here, there is a technique by which an inner end portion of the minor cutting edge is arranged further forward in a tool rotating direction than an outer end portion thereof by a posture in which the cutting insert for a face milling cutter is attached to the tool main body. That is, the cutting insert is attached to the tool main body in such a manner that a negative angle is imparted to the minor cutting edge of one cutting edge which is used for cutting by the cutting insert for a face milling cutter. Thereby, it is possible to provide effects of preventing fracture of the minor cutting edge.

However, in this case, in association with the above-described attachment posture, a flank face adjacent to the major cutting edge of the one cutting edge is also increased in flank angle. Thereby, it is difficult to secure the edge strength of the major cutting edge.

The present invention has been made in view of the above situation, the purpose of the present invention is to provide a cutting insert for a face milling cutter which is capable of sufficiently securing the edge strength of a cutting edge, thus making it possible to prevent edge fracture, and the like, to conduct a stable face milling operation and extend the tool life and also to provide an indexable face milling cutter in which the cutting insert is used.

### SUMMARY OF THE INVENTION

In order to attain the above object, the present invention has proposed the following aspects.

(1) A cutting insert for a face milling cutter in one aspect of the present invention is a cutting insert for a face milling cutter which is attached in a detachable manner to an insert seat formed on a tool main body of an indexable face milling cutter. The cutting insert is provided with an insert main body which is formed in a polygonal plate shape and in a shape of inversion symmetry on the front and back faces, a pair of polygonal faces, each face of which is configured to be a seating face, which faces in a thickness direction of the insert main body and is seated on the insert seat, or a rake face which faces to the opposite side of the insert seat, side faces which face in a direction intersecting with the thickness direction of the insert main body, and cutting edges which are formed along an outer circumference of the polygonal face, and each of the cutting edges constituting a ridge line between the polygonal face and the side face. Each of the polygonal faces is formed in a substantially regular polygonal shape which is rotational symmetry with respect to an insert axis passing through the center of the polygonal faces and extending in the thickness direction, each of the cutting edges is provided with a major cutting edge, a minor cutting edge which extends from the major cutting edge so as to form an obtuse angle with respect to the major cutting edge when the polygonal face is seen in the front and is configured to improve a finishing face of a workpiece, and a connecting edge which is positioned adjacent to the minor cutting edge so that the minor cutting edge is positioned between the major cutting edge and the connecting edge, in each two adjacent cutting edges adjacent to each other along the outer circumference of the polygonal face, the connecting edge of one of the two adjacent cutting edges connects the minor cutting edge of the one of the two adjacent cutting edges to the major cutting edge of the other of the two adjacent cutting edges, each of the side faces is provided with a first flank face which is arranged so as to be adjacent to the cutting edge and gradually inclines outward in an insert radial direction orthogonal to the insert axis as being spaced away from the cutting edge along a direction of the insert axis, and the first flank face is arranged so as to be adjacent at least to the major cutting edge of the cutting edge.

When the cutting insert for a face milling cutter is attached to the tool main body of the indexable face milling cutter to carry out a face milling operation to a workpiece, with regard to the plurality of cutting edges which constitute an outer circumference of one polygonal face which acts as a rake face (that is, the polygonal face facing in the tool rotating direction) of the pair of polygonal faces of the cutting insert for a face milling cutter, one cutting edge which is positioned at the outer circumferential part of the end of the tool main body is to be used for cutting. In this case, of the major cutting edge and the minor cutting edge of the one cutting edge, a finishing minor cutting edge configured to improve a finishing face of a workpiece is arranged on a flat face perpendicular to a tool axis of the tool main body.

According to the cutting insert for a face milling cutter of the present invention, the first flank face adjacent to a cutting edge is formed so as to gradually incline outward in the insert radial direction as being spaced away from the cutting edge. Therefore, cutting resistance on the minor cutting edge can be dispersed in an edge length direction thereof not by allowing the minor cutting edge to incline in the same direction as the major cutting edge of the one cutting edge when the insert main body is seen in a direction orthogonal to the insert axis (when the side face is seen in the front) or not by increasing a flank angle of the major cutting edge. More specifically, in the minor cutting edge, an inner portion (inner end portion) of the minor cutting edge arranged inside in the tool radial direction orthogonal to the tool axis can be arranged forward in the tool rotating direction with respect to the outer portion thereof (outer end portion) which is cut at a higher speed than the inner portion thereof. In other words, the major cutting edge is reliably increased in wedge angle. Thus, the cutting insert for a face milling cutter can be attached to the tool main body in such a manner that a radial rake angle of the minor cutting edge which is used for cutting together with the major cutting edge forms a negative angle. Further, the cutting resistance acting on the minor cutting edge can be dispersed evenly in the edge length direction of the minor cutting edge. Accordingly, not only the major cutting edge but also the minor cutting edge can be easily secured for the edge strength, quite effectively preventing edge fracture, and the like.

(2) The cutting insert for a face milling cutter in another aspect of the present invention is the cutting insert for a face milling cutter described in (1) in which when the polygonal face is seen in the front, the connecting edge extends so as to run along an extension line of the minor cutting edge adjacent to the connecting edge.

In this case, since the connecting edge which connects the minor cutting edge to the major cutting edge is formed integrally with the minor cutting edge, the major cutting edge can be accordingly secured for a greater edge length. It is, thus, possible to sufficiently enhance the cutting performance.

(3) The cutting insert for a face milling cutter in another aspect of the present invention is the cutting insert for a face milling cutter described in (1) or (2), in which the major cutting edge extends so as to gradually incline toward a middle part of the side face of the insert along the insert axis direction as being close to the connecting edge on the opposite side of the minor cutting edge adjacent to the major cutting edge.

In this case, when the cutting insert for a face milling cutter is attached to the tool main body, a sufficient positive angle can be imparted to an axial rake angle of the major cutting edge of one cutting edge which is used for cutting, thereby increasing the sharpness. Further, the major cutting edge can be increased in axial rake angle to give a positive angle. Therefore, in terms of a posture in which the cutting insert fir a face milling cutter is attached to the tool main body, it is possible to increase an extent in which the insert axis of the cutting insert gradually inclines to the end of the tool main body as being close to the forward in the tool rotating direction (a displacement amount per unit length in the tool rotating direction along the direction of the tool axis).

(4) The cutting insert for a face milling cutter in another aspect of the present invention is the cutting insert for a face milling cutter described in any one of (1) to (3), in which the minor cutting edge extends so as to gradually incline toward a middle part of the side face of the insert along the insert axis direction as being close to the connecting edge on the opposite side of the major cutting edge adjacent to the minor cutting edge.

In this case, it is possible to decrease a difference in height (a difference along the insert axis direction) between the cutting edge of one cutting edge which is used for cutting on machining and the connecting edge which connects the major cutting edge (the cutting edge not used for cutting) of the other cutting edge positioned on the opposite side of the major cutting edge of the one cutting edge adjacent to this minor cutting edge. It is, therefore, possible to easily conduct green compact press molding, or the like, in manufacturing the cutting insert for a face milling cutter. Further, since the connecting edge can be decreased in difference in height, the major cutting edge connected to the connecting edge can be reliably increased in edge length to sufficiently enhance the cutting performance.

(5) The cutting insert for a face milling cutter in another aspect of the present invention is the cutting insert for a face milling cutter described in any one of (1) to (4) in which each of the side faces is provided with a second flank face which is arranged on the opposite side of the cutting edge of the first flank face and in parallel with the insert axis.

In this case, for example, the second flank face is arranged at the center of the side face of the insert main body along the insert axis direction, thus making it possible to easily manufacture the cutting insert for a face milling cutter.

(6) An indexable face milling cutter in another aspect of the present invention is an indexable face milling cutter which is provided with a tool main body which is formed in a disk shape and rotated around a tool axis in a tool rotating direction and in which insert seats are formed at an outer circumferential part of the end of the tool main body, and the cutting insert for a face milling cutter described in any one of (1) to (5) which is attached to the insert seat in a detachable manner, in which the minor cutting edge, which is arranged at the end of the cutting insert for a face milling cutter attached to the insert seat in the tool axis direction gradually extends rearward in the tool rotating direction as being close to outward in the tool radial direction orthogonal to the tool axis.

According to the indexable face milling cutter of the present invention, the cutting insert for a face milling cutter can be attached to the tool main body in such a manner that a radial rake angle of the minor cutting edge of one cutting edge used for cutting forms a negative angle. Therefore, the cutting resistance on the minor cutting edge can be dispersed evenly in the edge length direction of the minor cutting edge to sufficiently secure the edge strength. It is, thereby, possible to prevent edge fracture of the minor cutting edge, and the like, conduct of face milling operation stably and also extend the tool life of the cutting insert for a face milling cutter.

According to the cutting insert for a face milling cutter and the indexable face milling cutter in the present invention, it is possible to sufficiently secure the edge strength of the cutting edge. Thereby, it is also possible to prevent edge fracture and the like, conduct a face milling operation stably and also extend the tool life.

### BRIEF DESCRIPTION OF THE DRAWINGS

FIG. 1 is a perspective view which shows an indexable face milling cutter to which a cutting insert for a face milling cutter of one embodiment of the present invention is attached.

FIG. 2 is a bottom view which shows the indexable face milling cutter to which the cutting insert for a face milling cutter of one embodiment of the present invention is attached.

FIG. 3 is a side elevational view which shows the indexable face milling cutter to which the cutting insert for a face milling cutter of one embodiment of the present invention is attached.

FIG. 4 is a perspective view which enlarges the vicinity of the cutting insert for a face milling cutter mounted on an insert seat of the tool main body.

FIG. 5 is a perspective view which enlarges the vicinity of the insert seat of the tool main body.

FIG. 6 is a front elevational view which enlarges the vicinity of the cutting insert for a face milling cutter mounted on the insert seat of the tool main body. In detail, this is a view in which a rake face of the cutting insert for a face milling cutter is seen in the front and a workpiece is indicated by using a chain double-dashed line.

FIG. 7 is a view which shows a cross section taken along an F to F line in FIG. 6 and a machined surface of the workpiece is indicated by using a chain double-dashed line.

FIG. 8 is a perspective view which shows the cutting insert for a face milling cutter in one embodiment of the present invention.

FIG. 9 is a planar view (top view or bottom view) which shows the cutting insert for a face milling cutter in one embodiment of the present invention.

FIG. 10 is a side elevational view which shows the cutting insert for a face milling cutter in one embodiment of the present invention.

FIG. 11 is a view which shows a cross section taken along an A-A line in FIG. 9.

FIG. 12 is a view which shows a cross section taken along a B-B line in FIG. 9.

FIG. 13 is a view which shows a cross section taken along a C-C line in FIG. 9.

FIG. 14 is a perspective view taken from an arrow D in FIG. 9.

### DETAILED DESCRIPTION OF THE INVENTION

Hereinafter, with reference to drawings, a description will be given of a cutting insert for a face milling cutter 1 in one embodiment of the present invention (hereinafter abbreviated as the cutting insert 1) and an indexable face milling cutter 30 which uses the cutting insert.

The cutting insert 1 of the present embodiment is to carry out a face milling operation to a workpiece made of a metal material or the like, and the indexable face milling cutter 30 in which the cutting insert 1 is used is a face milling cutter.

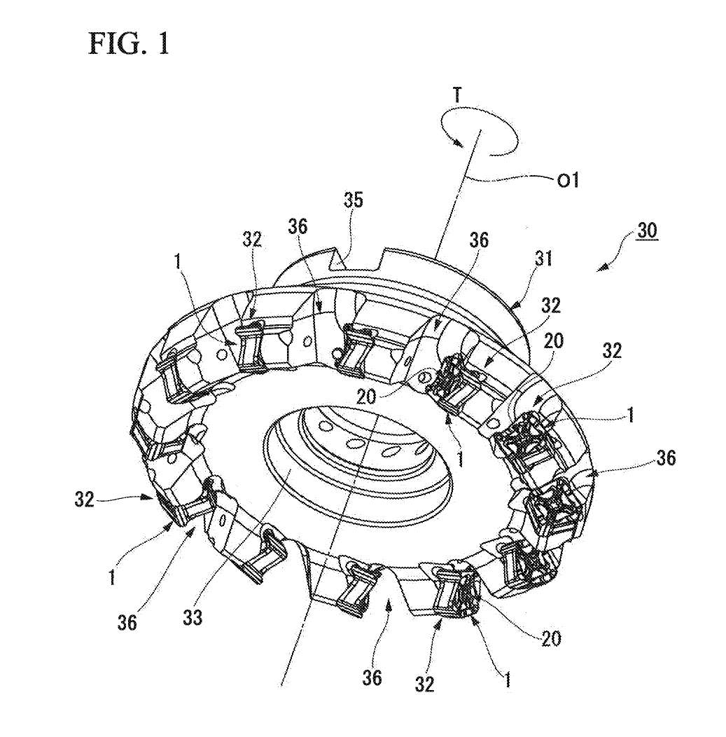

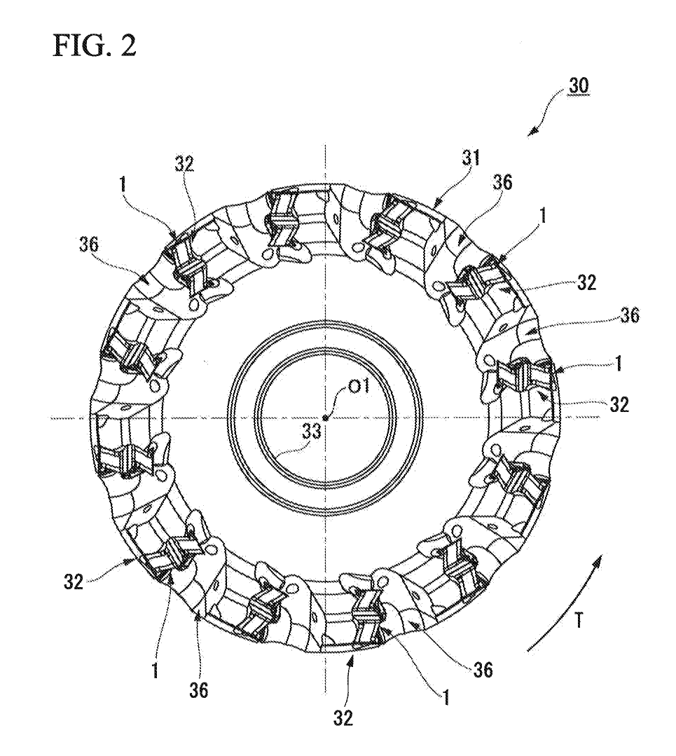

As shown in FIG. 1 to FIG. 3, the indexable face milling cutter 30 is provided with a tool main body 31 which is formed in a disk shape made of a steel material or the like and rotated around a tool axis O1 in a tool rotating direction T and in which a plurality of insert seats 32 are formed at an outer circumferential part of the end thereof, with an interval kept in the circumferential direction, a plurality of cutting inserts 1 each of which is made of a hard material such as a cemented carbide and attached to the insert seat 32 in a detachable manner, and a clamp screw 20 which is made of a steel material or the like, inserted into an attachment hole 7 on the cutting insert 1 to be described later and screwed into the insert seat 32 to fix the cutting insert 1 to the tool main body 31.

The cutting insert 1 can be detached from the tool main body 31 by loosening the clamp screw 20 which has been screwed into the insert seat 32 to remove the clamp screw 20 from the insert seat 32. Therefore, the cutting insert 1 is detachable from the insert seat 32 of the tool main body 31.

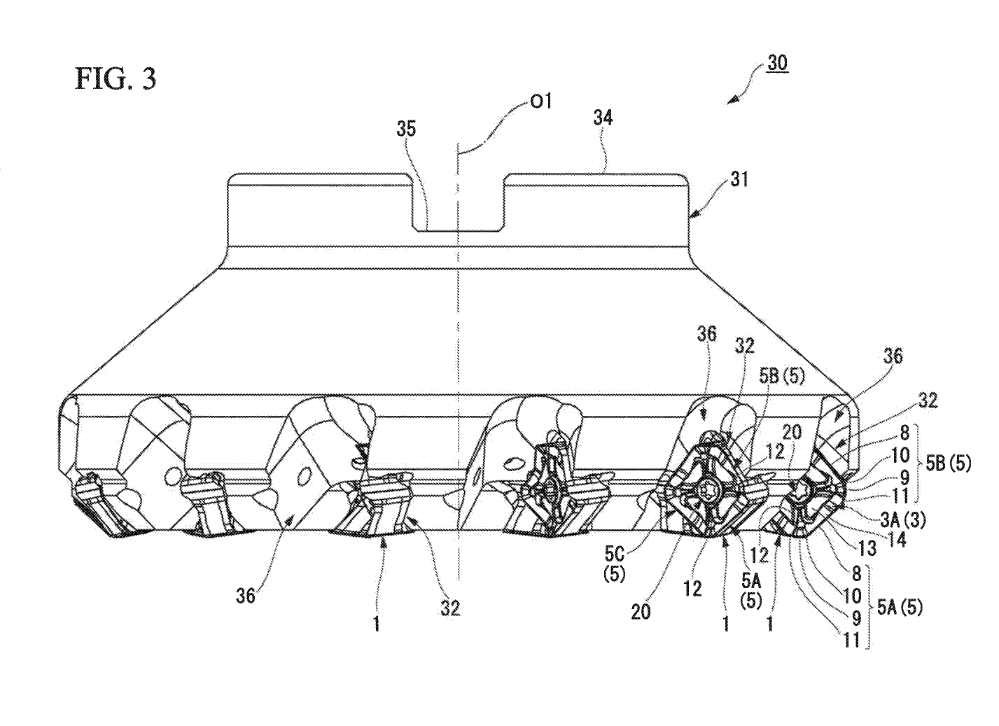

The tool main body 31 is formed in a disk shape centered about the tool axis O1 (the disk shape referred to in this description includes a cylindrical shape). A tool attachment hole 33 which extends along the tool axis O1 is formed on the tool main body 31 so as to penetrate through the tool main body 31. Further, a key way 35 which extends from an opening border portion of the tool attachment hole 33 outward in a radial direction is formed on an end face 34 which faces a base end (on the upper side in FIG. 3) of the tool main body 31 along a direction of the tool axis O1. In a state that the key way 35 is fitted into a key installed at an end portion of a main shaft of a machine tool (not illustrated), the tool main body 31 is mounted on the end portion of the main shaft by using a bolt member inserted through the tool attachment hole 33, rotated around the tool axis O1 in the tool rotating direction T and used for cutting a workpiece.

In this specification, a direction at which the tool main body 31 is rotated around the tool axis O1 on machining a workpiece is referred to as forward in a tool rotating direction Y or in a tool rotating direction T, and a reverse direction thereof (a direction reverse to tool rotation) is referred to as rearward in the tool rotating direction T.

At an end of the end of the tool main body 31 along the direction of the tool axis O1 (below in FIG. 3), there is formed a chip pocket 36 which is opened at the end and also outward in the radial direction so that an outer face of the tool main body 31 is notched. The plurality of chip pockets 36 are formed at an outer circumferential part of the end of the tool main body 31, with an interval kept in the circumferential direction.

The chip pocket 36 is provided with an insert seat 32 which is positioned at the end of the tool main body 31, is positioned at rearward in the tool rotating direction T in the chip pocket 36 and faces forward in the tool rotating direction T. The chip pocket 36 is also provided with a coolant supply hole which is opened toward a cutting edge 5 of the cutting insert 1 attached to the insert seat 32. The insert seat 32 is formed in a concave manner on a wall face of the chip pocket 36 facing forward in the tool rotating direction T so as to correspond to a shape of the cutting insert 1.

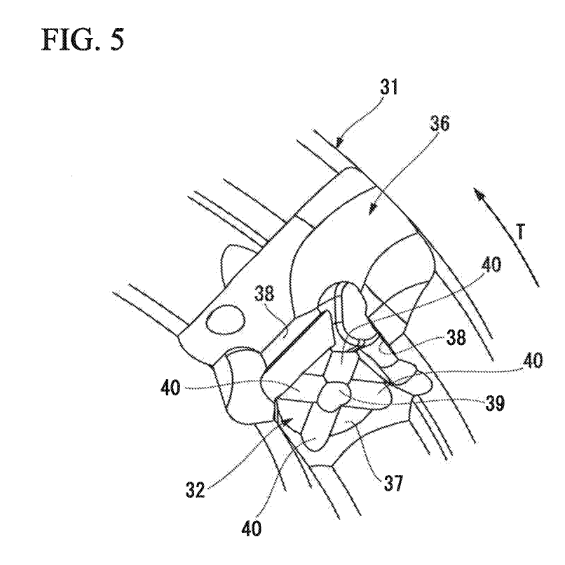

As shown in FIG. 5, the insert seat 32 is formed in a shape of a polygonal hole so as to correspond to the shape of the cutting insert 1 which is formed in a shape of a polygonal plate. It is noted that the insert seat 32 may include any shape in which a seating portion 13 of the cutting insert 1 to be described later can be seated, and the shape thereof is not limited to the polygonal hole. The insert seat 32 is provided with a bottom wall 37 which is in contact with the seating portion 13 of the cutting insert 1 to be described later and a pair of side walls 38 which are in contact with the side faces 4 of the cutting insert 1.

The bottom wall 37 is provided with an internal thread hole 39 in which the clamp screw 20 is drilled so as to be tightly screwed and a plurality of recessed portions 40 which are formed in a shape of a groove so as to correspond to a ridge portion 12 of the cutting insert 1 to be described later. In FIG. 5, the internal thread hole 39 is arranged at the center of the bottom wall 37, and the plurality of recessed portions 40 extend in an X letter shape centered about the internal thread hole 39.

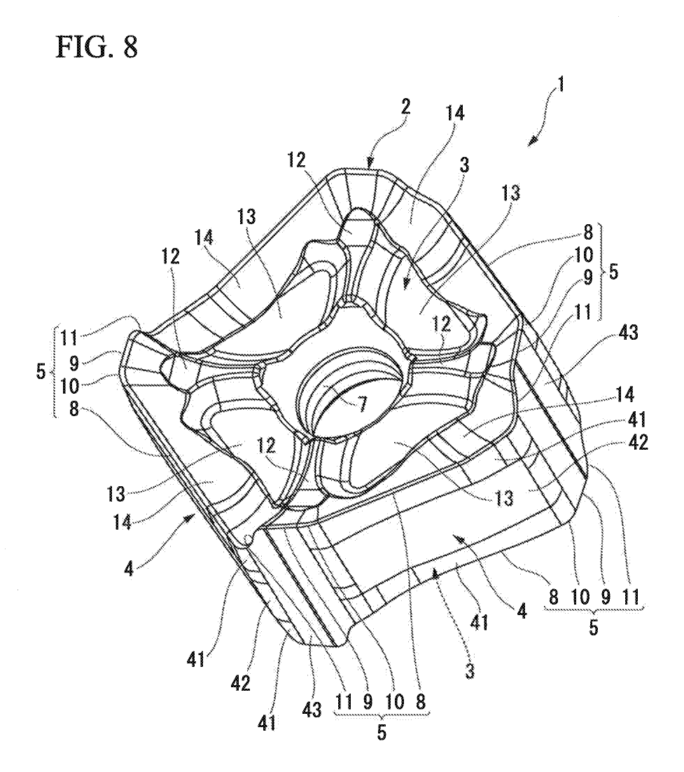

As shown in FIG. 8 to FIG. 14, the cutting insert 1 is provided with an insert main body 2 which is formed in a polygonal plate shape and in a shape of inversion symmetry on the front and back faces, a pair of polygonal faces 3, each face of which is configured to be a seating face, which faces in the thickness direction of the insert main body 2 and is seated on the insert seat 32, or a rake face which faces to the opposite side of the insert seat 32 (that is, in the tool rotating direction T), a plurality of side faces 4 which face in a direction intersecting with the thickness direction of the insert main body 2 (to be more specific, a direction substantially perpendicular to the thickness direction) and a plurality of cutting edges 5 which are formed along an outer circumference of the polygonal face 3, and each of the cutting edges 5 constituting a ridge line between the polygonal face 3 and the side face 4.

That is, the cutting insert 1 is a both-side type cutting insert for a face milling cutter.

In this specification, “the thickness direction” of the insert main body 2 is a direction along an insert axis O2 which is the central axis of the attachment hole 7 described later. The insert axis O2 is an axis which passes through the center of the pair of polygonal faces 3.

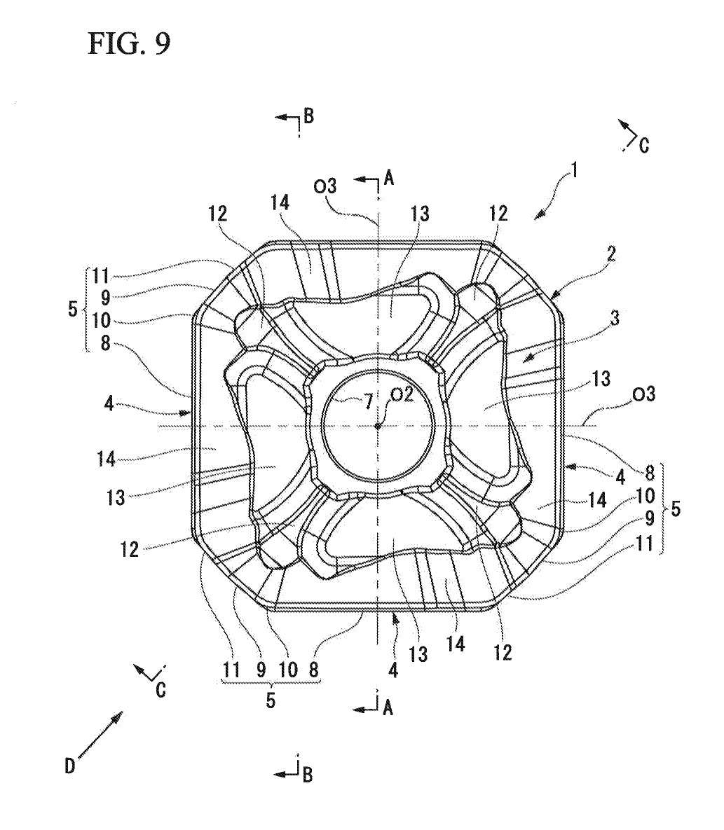

The insert main body 2 of the present embodiment is formed substantially in the shape of a square plate, and each of the pair of polygonal faces 3 is formed in the shape of a square. In detail, as shown in FIG. 9, the polygonal face 3 is formed in a substantially regular polygonal shape which is rotational symmetry with respect to the insert axis O2 passing through the center of the polygonal face 3 and extending in the thickness direction. In the present embodiment, the polygonal face 3 is formed in a substantially square shape and the polygonal face 3 is in the shape of 90° rotational symmetry with respect to the insert axis O2.

Further, the insert main body 2 is provided with an attachment hole 7 which goes through the insert main body 2 in the insert axis direction O2 and is opened at the center of the pair of polygonal faces 3 (on the insert axis O2). As shown in FIG. 11, an opening portion of the attachment hole 7 (both ends along the insert axis direction O2) is made greater in diameter than other portions excluding the opening portion and gradually increased in diameter as being close to outward from the insert along the insert axis direction O2.

Further, in FIG. 9, the insert main body 2 is orthogonal to the insert axis O2 and in the shape of 180° rotational symmetry with respect to a symmetrical line O3 passing through the center of the side face 4. Thereby, the insert main body 2 and the cutting insert 1 are formed in the shape of inversion symmetry on the front and back faces.

FIG. 8 to FIG. 10, the plurality of cutting edges 5 are formed on an outer circumferential end portion of the polygonal face 3. In the present embodiment, the polygonal face 3 is formed substantially in a shape of a square face having four sides and four corners. More specifically, the polygonal face 3 is provided with four long sides constituting the above-described sides as well as four short sides and eight angular portions which constitute the corners. Specifically, the polygonal face 3 is formed in a shape of an octagonal plane, and four sets of cutting edges 5, each of which has one long side (a major cutting edge 8 to be described later) and one short side (a minor cutting edge 9 and a connecting edge 11 to be described later), are arranged along a circumferential direction of the polygonal face 3. It is noted that the circumferential direction is a direction going around the insert axis O2.

The cutting edge 5 is provided with a major cutting edge 8 which is formed at a region (side) corresponding to the long side in the outer circumferential end portion of the polygonal face 3 and also used for main cutting, a finishing minor cutting edge (flat cutting edge) 9 which is formed at a region (corner) corresponding to the short side, extends from the major cutting edge so as to form an obtuse angle with respect to the major cutting edge 8 when the polygonal face 3 is seen in the front and is configured to improve a finishing face of a workpiece, a connecting edge 11 which is formed at a region (corner) corresponding to the short side and positioned on the opposite side of the major cutting edge 8 of the minor cutting edge 9 (that is, a connecting edge 11 which is positioned adjacent to the minor cutting edge 9 so that the minor cutting edge 9 is positioned between the major cutting edge 8 and the connecting edge 11), and a corner edge 10 which is formed at a region (corner) corresponding to an angular portion between the long side and the short side and smoothly connects the major cutting edge 8 to the minor cutting edge 9.

It is acceptable that the corner edge 10 is not provided.

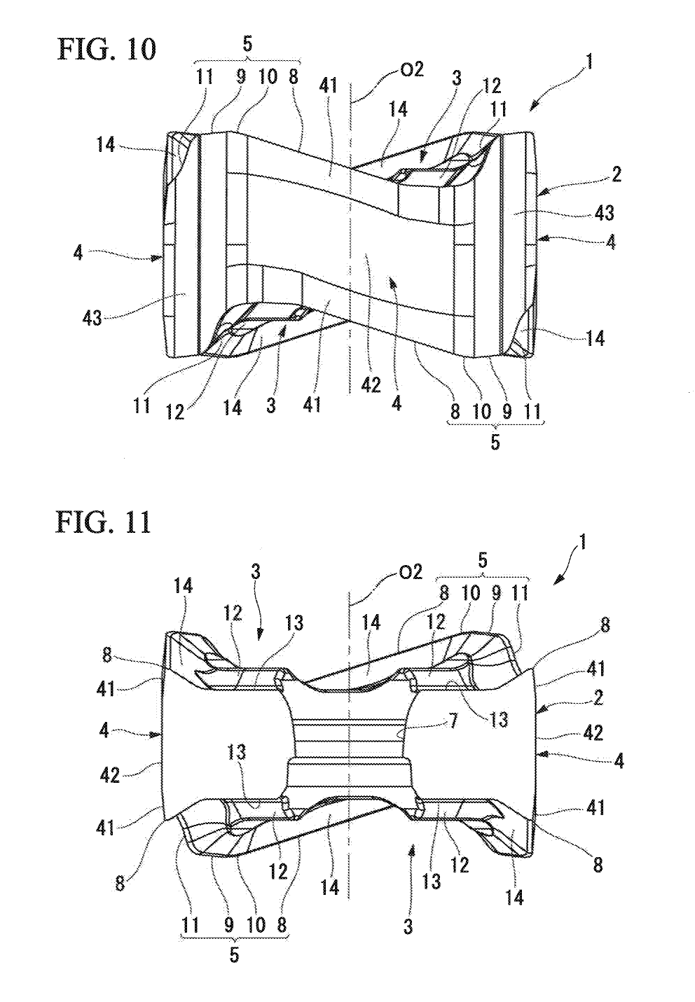

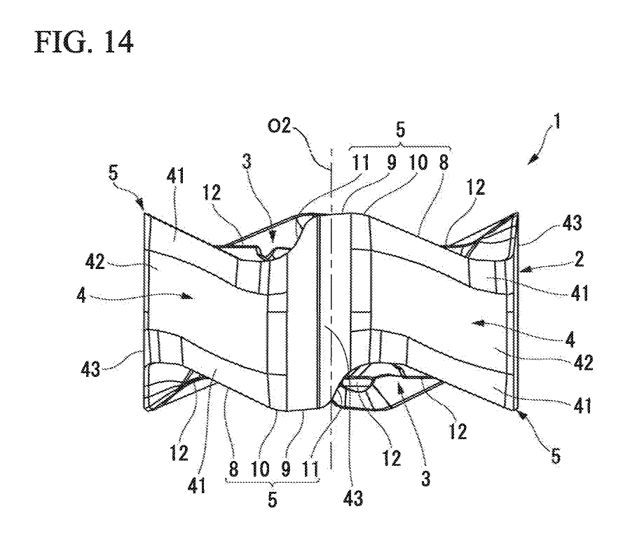

When seen laterally in FIG. 10, the major cutting edge 8 of the cutting edge 5 extends so as to gradually incline toward a middle part of the side face of the insert along the insert axis direction O2 as being close to the connecting edge 11 on the opposite side of the minor cutting edge 9 adjacent to the major cutting edge 8 (a minor cutting edge 9 adjacent to the major cutting edge 8 across a corner edge 10 in the present embodiment). Further, when seen laterally in FIG. 14, the minor cutting edge 9 of the cutting edge 5 extends so as to gradually incline toward a middle part of the side face of the insert along the insert axis direction O2 as being close to the connecting edge 11 on the opposite side of the major cutting edge 8 adjacent to the minor cutting edge 9 (the major cutting edge 8 adjacent to the minor cutting edge 9 across the corner edge 10 in the present embodiment). It is acceptable that the minor cutting edge 9 extends on a virtual flat face perpendicular to the insert axis O2. Further, the corner edge 10 is formed in a shape of a convex curve when seen laterally in FIG. 10 and FIG. 14 and also when seen from above in FIG. 9. Here, the middle part is an area locating at the center in the width along the insert direction of each side surface of the insert.

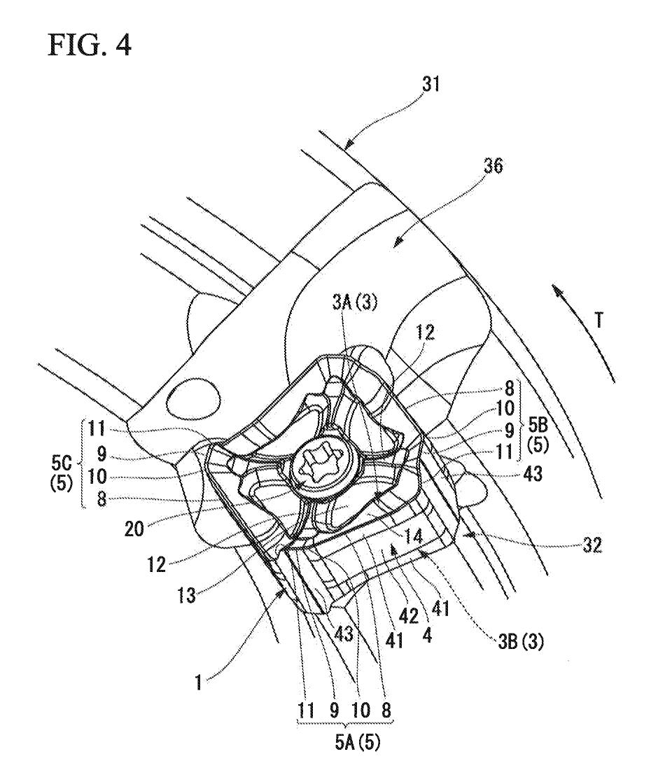

Further, as shown in FIG. 4, of the pair of cutting edges 5 mutually adjacent in a circumferential direction (that is, in each two adjacent cutting edges 5 adjacent to each other) along an outer circumference of the polygonal face 3, the connecting edge 11 of one of the two adjacent cutting edges 5 (for example, a cutting edge 5A) connects the minor cutting edge 9 of one of the two adjacent cutting edges 5 (the cutting edge 5A) to the major cutting edge 8 of the other of two adjacent cutting edges 5 (a cutting edge 5C). Still further, the major cutting edge 8 of one of the two adjacent cutting edges 5 (for example, the cutting edge 5A) is smoothly connected to the minor cutting edge 9 of the other of two adjacent cutting edges 5 (a cutting edge 5B) by the connecting edge 11 of the other of the two adjacent cutting edges 5 (the cutting edge 5B). The connecting edge 11 extends so as to gradually incline toward a middle part of the side face of the insert along the insert axis direction O2 as being close to the major cutting edge 8 on the opposite side of the minor cutting edge 9 adjacent to the connecting edge 11. More specifically, the connecting edge 11 is provided with a concave curved portion longer in edge length and a convex curved portion shorter in edge length and formed as a whole in the shape of a concave curve. At the connecting edge 11, the convex curved portion shorter in edge length is arranged on the side of the minor cutting edge 9 adjacent to the connecting edge 11, while the concave curved portion longer in edge length is arranged on the side of the major cutting edge 8 adjacent to the connecting edge 11. The connecting edge 11 is not an edge which is cut into a workpiece and, therefore, may not be formed to give an acute edge.

Further, when the polygonal face 3 is seen in the front as shown in FIG. 9, the connecting edge 11 extends so as to run along an extension line of the minor cutting edge 9 adjacent to the connecting edge 11. That is, when the polygonal face 3 is seen in the front, the connecting edge 11 is formed in a linear shape so as to constitute a short side of the polygonal face 3 together with the minor cutting edge 9 adjacent thereto and also extends so as to form an obtuse angle with respect to the major cutting edge 8 which constitutes a long side of the polygonal face 3. More specifically, when the polygonal face 3 is seen in the front as shown in FIG. 9, the connecting edge 11 is arranged so as to substantially overlap on the extension line of the minor cutting edge 9 adjacent thereto and also slightly retracted toward the insert axis O2 from the extension line (inside an insert radial direction to be described later).

Further, as shown in FIG. 8 and FIG. 9, the polygonal face 3 is provided with a ridge portion 12 which extends so as to move toward the center of the polygonal face 3 from the minor cutting edge 9 of the cutting edge 5, a seating portion 13 which is arranged so as to be adjacent to the ridge portion 12 and retracted inside the insert along the insert axis direction O2 from the ridge portion 12, and a breaker 14 which extends so as to run along the cutting edge 5.

When seen from above as shown in FIG. 9, the ridge portion 12 extends so as to be orthogonal to the insert axis O2 toward the attachment hole 7 positioned at the center of the polygonal face 3 from the minor cutting edge 9 positioned at the short side (corner) at an outer circumferential end portion of the polygonal face 3. In other words, the ridge portion 12 extends between the short side at the outer circumferential end portion of the polygonal face 3 and the center of the polygonal face 3. In the present embodiment, the four ridge portions 12 are formed in a radial manner centered about the insert axis O2 corresponding to the four short sides of the polygonal face 3. Further, a width (length along a circumferential direction of the polygonal face 3) of an upper end face of the ridge portion 12 (an end face facing outward from the insert along the insert axis direction O2) is the widest in the vicinity of the short side of the polygonal face 3 and becomes gradually narrow toward the center from the vicinity of the short side. On the other hand, a bottom of the ridge portion 12 is substantially constant in width along a direction at which the ridge portion 12 extends.

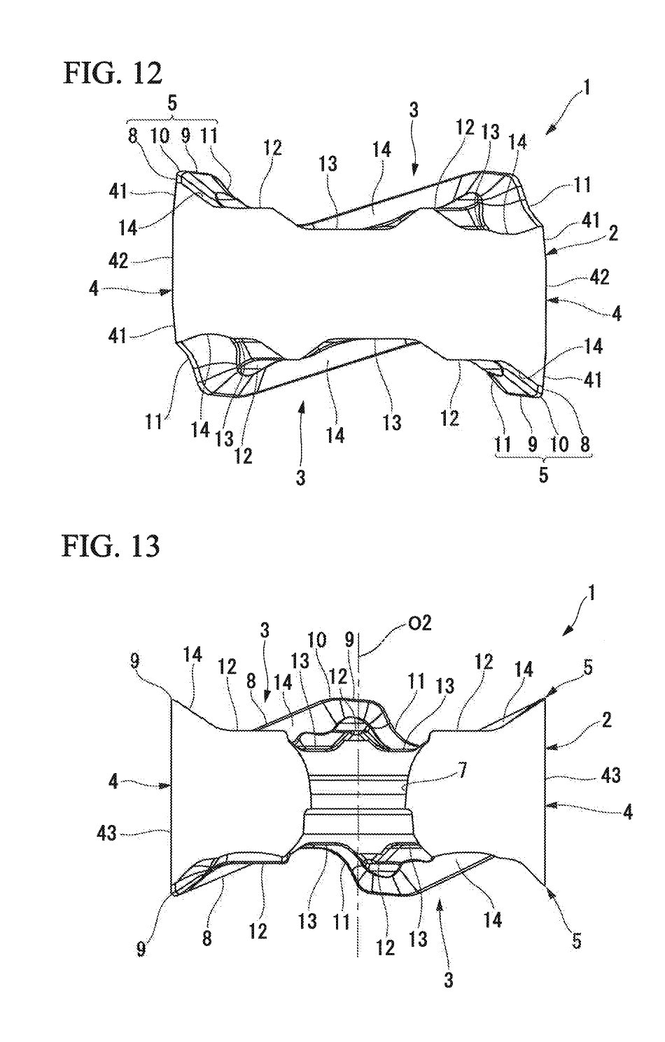

In FIG. 11 and FIG. 12, the ridge portion 12 (length along the insert axis direction O2) is substantially constant in height at a center part along a direction at which the ridge portion 12 extends. A portion positioned at the short side of the polygonal face 3 from the center part is made higher than the center part, while a portion positioned closer to the center of the polygonal face 3 from the center part is made lower than the center part. An inner end of the ridge portion 12 which faces the attachment hole 7 (an end positioned at the center of the polygonal face 3 from the center) is arranged in such a manner so as not to be in contact with a head of the clamp screw 20 before an opening portion of the attachment hole 7 upon insertion of the clamp screw 20 into the attachment hole 7. Thereby, the head of the clamp screw 20 is brought into contact with an entire circumference of the opening portion of the attachment hole 7 to enhance friction resistance. At the same time, a fastening force is secured to prevent the clamp screw 20 from easily loosening.

Further, the ridge portion 12 is gradually decreased in height toward the seating portion 13 adjacent in the circumferential direction thereof, by which the side face of the ridge portion 12 is given as an inclination face. Still further, the width of the ridge portion 12 becomes gradually wider toward the inside of the insert along the insert axis direction O2. That is, the shape of the vertical section of the ridge portion 12 has a convex shape which becomes gradually wider toward the base of the ridge portion 12 from the top of the ridge portion 12.

As shown in FIG. 8 and FIG. 9, the seating portion 13 is formed between the ridge portions 12 adjacent in the circumferential direction on the polygonal face 3. In the present embodiment, the seating portion 13 is formed in a shape of a flat plate (in the shape of a flat face) perpendicular to the insert axis O2. The seating portion 13 is formed in the shape of a triangle or trapezoid so as to correspond to a triangle-planar flat portion (refer to FIG. 5) formed between mutually adjacent recessed portions 40 on a bottom wall 37 of the insert seat 32 to which the cutting insert 1 is attached.

In FIG. 8 and FIG. 9, the breaker 14 is formed inside the cutting edge 5 on the polygonal face 3 so as to be adjacent to the cutting edge 5. The breaker 14 is formed at least between the seating portion 13 and the cutting edge 5 on the polygonal face 3, assuming a groove shape or an inclined planar shape extending along the cutting edge 5. In the present embodiment, the breaker 14 is formed along an outer circumference of the polygonal face 3 from a space between the seating portion 13 and the cutting edge 5 (the major cutting edge 8) to a space between the ridge portion 12 and the cutting edge 5 (the minor cutting edge 9).

When seen from above as shown in FIG. 9, the width of the breaker 14 becomes wider gradually or in a stepwise manner toward the major cutting edge 8 from the minor cutting edge 9 of the cutting edge 5 to which the breaker 14 is adjacent. In the illustrated example, a portion of the breaker 14 which is adjacent to the major cutting edge 8 of the cutting edge 5 is formed so as to become gradually wider in width toward the opposite side of the minor cutting edge 9 adjacent to the major cutting edge 8.

As shown in FIG. 11 to FIG. 13, the breaker 14 gradually inclines toward the inside of the insert along the insert axis direction O2 as being spaced away from the cutting edge 5 positioned at an outer circumferential end portion of the polygonal face 3 to the center of the polygonal face 3. Further, as shown in FIG. 8, FIG. 11, FIG. 12, and so on, the breaker 14 changes in its height along the circumferential direction so as to correspond to the fact that the cutting edge 5 to which the breaker 14 is adjacent changes in position along the insert axis direction O2 (that is, the height) in the circumferential direction (the edge length direction of the cutting edge 5).

More specifically, the breaker 14 becomes the highest at a portion corresponding to the minor cutting edge 9 of the cutting edge 5 to which the breaker 14 is adjacent and gradually becomes lower toward the major cutting edge 8 from the corner edge 10. Next, at least a part of the breaker 14 is retracted inside the insert along the insert axis direction O2 from the seating portion 13.

More specifically, with regard to the height of the breaker 14, a portion positioned at the minor cutting edge 9 adjacent to the major cutting edge 8 from the center of the major cutting edge 8 of the cutting edge 5 to which the breaker 14 is adjacent, the minor cutting edge 9 and a region corresponding to the corner edge 10 positioned between them are made higher than the seating portion 13. With regard to the height of the breaker 14, a region corresponding to a portion positioned on the opposite side (on the side of the connecting edge 11) of the minor cutting edge 9 adjacent to the major cutting edge 8 from the center of the major cutting edge 8 is, however, made lower than the seating portion 13 (refer to FIG. 12). Further, accordingly, the breaker 14 is such that a portion positioned at the minor cutting edge 9 adjacent to the major cutting edge 8 from the center of the major cutting edge 8, the minor cutting edge 9, and a region corresponding to the corner edge 10 between them are tinned an inclined plane shape. Moreover, a region corresponding to a portion positioned on the opposite side of the minor cutting edge 9 adjacent to the major cutting edge 8 from the center of the major cutting edge 8 is formed a groove shape.

Next, as shown in FIG. 8, FIG. 11, FIG. 12, and so on, the side face 4 is provided with a first flank face 41 which is arranged so as to be adjacent to the cutting edge 5 and gradually inclines outward in the insert radial direction orthogonal to the insert axis O2 as being spaced away from the cutting edge 5 in the insert axis direction O2 and a second flank face 42 which is arranged on the opposite side of the cutting edge 5 of the first flank face 41 and in parallel with the insert axis O2.

As described above, the cutting insert 1 of the present embodiment is in the shape of inversion symmetry on the front and back faces. Therefore, the pair of first flank faces 41 are formed at both ends of the side face 4 in the insert axis direction O2, and between the first flank faces 41 there is formed the second flank face 42 which protrudes outward in the insert radial direction from the first flank face 41. Further, in a state that the cutting insert 1 is attached to the insert seat 32, the second flank face 42 on the side face 4 of the cutting insert 1 is brought into contact with each of a pair of side walls 38 of the insert seat 32.

The first flank face 41 is arranged so as to be adjacent at least to the major cutting edge 8 of the cutting edge 5.

More specifically, in the present embodiment, the first flank face 41 is formed so as to be adjacent to the major cutting edge 8 and the corner edge 10 of the cutting edge 5. Further, a portion of the first flank face 41 which is adjacent to the major cutting edge 8 is formed in a shape of a flat face, and a portion adjacent to the corner edge 10 is formed in a shape of a convex curved surface.

The second flank face 42 is formed on the opposite side of the major cutting edge 8 and the corner edge 10 of the first flank face 41 on the side face 4, corresponding to a region at which the above-described first flank face 41 is formed. Further, a portion of the second flank face 42 corresponding to the major cutting edge 8 along the insert circumferential direction (the direction around the insert axis O2) is formed in a shape of a flat face, and a portion corresponding to the corner edge 10 along a circumferential direction of the insert is formed in a shape of a convex curved surface.

A portion of the side face 4 which is adjacent to the minor cutting edge 9 of the cutting edge 5 is given as a third flank face 43 in parallel with the insert axis O2. The third flank face 43 is formed all over the length of the side face 4 in the insert axis direction O2. Further, the third flank face 43 is formed in a shape of a flat face. It is acceptable that in such a manner that the major cutting edge 8 used for cutting is further increased in axial rake angle on attachment of the cutting insert 1 to the tool main body 31, the third flank face 43 adjacent to the minor cutting edge 9 is formed so as to gradually incline inside the insert radial direction as being spaced away from the minor cutting edge 9. Still further, the minor cutting edge 9 and the connecting edge 11 are arranged so as to face to the opposite side from each other at both end borders of the third flank face 43 in the insert axis direction O2.

The first flank face 41 and the third flank face 43 are arranged so as to be adjacent in the insert circumferential direction at a portion of the side face 4 adjacent to the connecting edge 11. More specifically, at a portion adjacent to the connecting edge 11 of the side face 4, a portion positioned at the minor cutting edge 9 adjacent to the connecting edge 11 is given as the third flank face 43, while a portion positioned at the major cutting edge 8 adjacent to the connecting edge 11 is given as the first flank face 41.

Further, although not illustrated in particular, the clamp screw 20 is provided with a screw shaft portion on which external threads are performed and a head greater in diameter than the screw shaft portion. The screw shaft portion of the clamp screw 20 is tightly screwed into an internal thread hole 39 of the insert seat 32 (refer to FIG. 5).

As shown in FIG. 4, in a state that the clamp screw 20 is used to attach the cutting insert 1 to the insert seat 32 of the tool main body 31, of the pair of polygonal faces 3, one polygonal face 3A is arranged to face forward in the tool rotating direction T and configured to be a rake face. Further, of the pair of polygonal faces 3, the other polygonal face 3B is arranged so as to face rearward in the tool rotating direction T and configured to be a seating face on which the other polygonal face 3B is seated on the bottom wall 37 of the insert seat 32 shown in FIG. 5.

More specifically, the seating portion 13 on the other polygonal face 3B is brought into contact with the bottom wall 37, and a ridge portion 12 adjacent to the seating portion 13 is housed inside a recessed portion 40 of the bottom wall 37. Further, the side face 4 of the cutting insert 1 is brought into contact with each of the pair of side walls 38 of the insert seat 32.

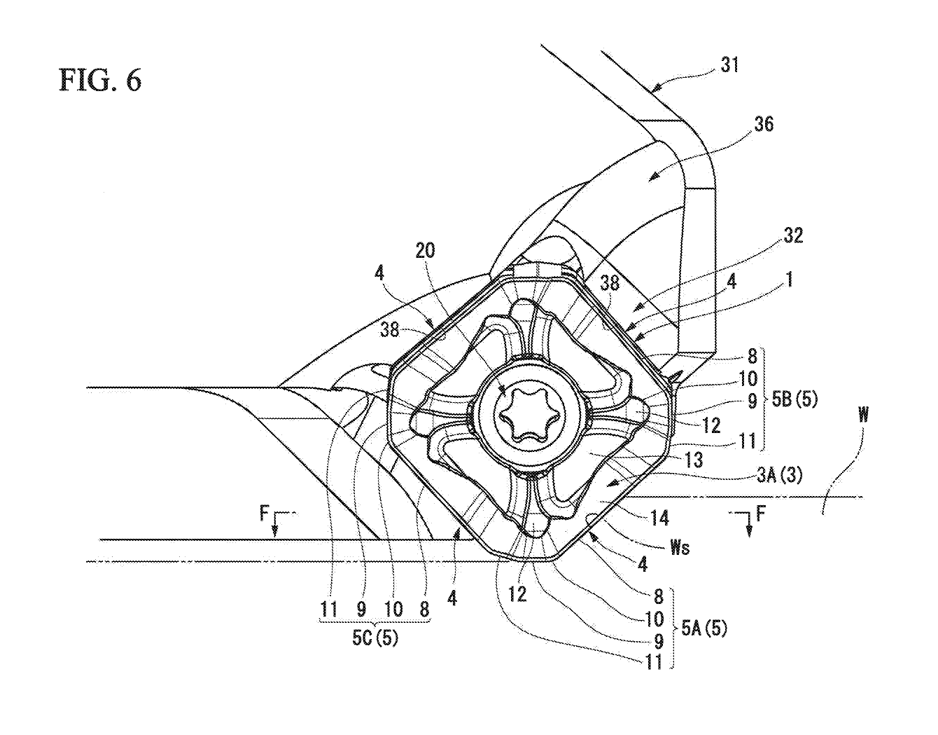

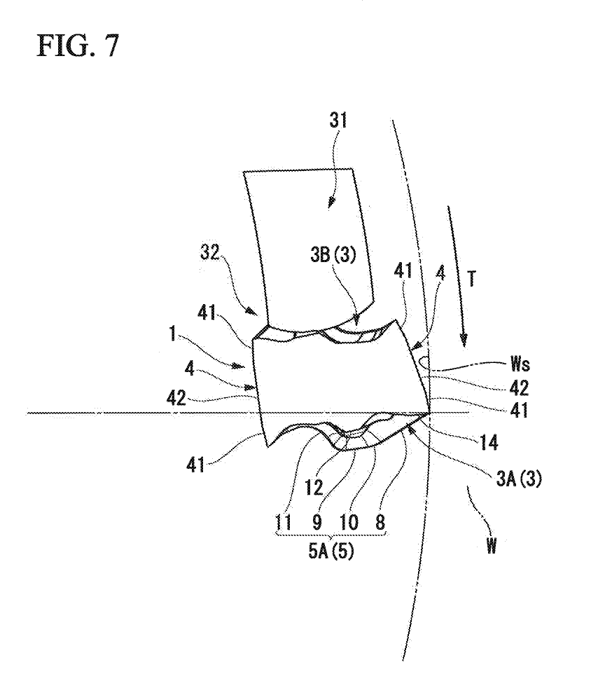

In FIG. 4 and FIG. 6, when the cutting insert 1 is attached to a tool main body 31 of an indexable face milling cutter 30 to carry out a face milling operation to a workpiece W, of a plurality of cutting edges 5 which constitute an outer circumference of one polygonal face 3A configured to be a rake face (that is, the face which faces in the tool rotating direction T) of the pair of polygonal faces 3A, 3B of the cutting insert 1, used for cutting is one cutting edge 5A positioned at an outer circumferential part of the end of the tool main body 31 (below on the right in FIG. 6). In this case, of the major cutting edge 8 and the minor cutting edge 9 of the one cutting edge 5A, a finishing minor cutting edge 9 configured to improve a finishing face of the workpiece W is arranged on a flat face perpendicular to the tool axis O1 of the tool main body 31. However, as shown in FIG. 7, an inner portion (an inner end portion or a left-side portion of the minor cutting edge 9 in FIG. 7) of the minor cutting edge 9 arranged inside in the tool radial direction orthogonal to the tool axis O1 at the minor cutting edge 9 is arranged so as to be forward in the tool rotating direction T with respect to an outer portion (an outer end portion or a right-side portion of the minor cutting edge 9 in FIG. 7) which is cut at a higher speed than the inner portion.

In other words, the minor cutting edge 9 arranged at the end of the cutting insert 1 attached to the insert seat 32 in the direction of the tool axis O1 (that is, the minor cutting edge 9 of one cutting edge 5A used for cutting) gradually extends rearward in the tool rotating direction T, toward outward in the tool radial direction orthogonal to the tool axis O1. That is, the cutting insert 1 is attached to the tool main body 31 in such a manner that a radial rake angle of the minor cutting edge 9 is formed to give a negative angle. Thereby, cutting resistance acting on the minor cutting edge 9 is evenly dispersed in the edge length direction of the minor cutting edge 9 to provide effects of preventing edge fracture of the minor cutting edge 9, and the like.

That is, according to the cutting insert 1 of the present embodiment, the first flank face 41 adjacent to the cutting edge 5 is formed so as to gradually incline outward in the insert radial direction as being spaced away from the cutting edge 5. Therefore, when the insert main body 2 is seen in a direction orthogonal to the insert axis O2 (when the side face 4 is seen in the front), the minor cutting edge 9 of the one cutting edge 5A is not allowed to incline in the same direction as the major cutting edge 8 or the major cutting edge 8 is not increased in flank angle, thus making it possible to disperse cutting resistance on the minor cutting edge 9 in the edge length direction thereof. More specifically, where a conventional cutting insert for a face milling cutter is attached to a tool main body in such a posture that the cutting insert of the present embodiment is attached as described above, a flank face adjacent to a major cutting edge of one cutting edge used for cutting is greatly spaced away from a machined surface Ws of a workpiece W to result in an increase in flank angle (refer to FIG. 7). It is, therefore, difficult to sufficiently secure the edge strength. On the other hand, according to the present embodiment, the major cutting edge 8 is reliably increased in wedge angle. Therefore, the cutting insert 1 can be attached to the tool main body 31 in such a manner that a radial rake angle of the minor cutting edge 9 used for cutting together with the major cutting edge 8 forms a negative angle. Cutting resistance acting on the minor cutting edge 9 can be evenly dispersed in the edge length direction of the minor cutting edge 9, by which not only the major cutting edge 8 but also the minor cutting edge 9 can be easily secured for the edge strength to provide remarkable effects of preventing edge fracture, and the like. Next, since the first flank face 41 is arranged so as to be adjacent at least to the major cutting edge 8 of the cutting edge 5, it is possible to reliably provide the above-described effects.

As described so far, according to the present embodiment, one cutting edge 5A used for cutting is sufficiently secured for the edge strength, thus making it possible to prevent edge fracture, and the like, for realizing a stable face milling operation and also extend the tool life.

Further, when the polygonal face 3 is seen in the front, the connecting edge 11 extends so as to run along an extension line of the minor cutting edge 9 adjacent to the connecting edge 11. Thus, the following effects can be provided.

That is, since the connecting edge 11 which connects the minor cutting edge 9 to the major cutting edge 8 is formed integrally with the minor cutting edge 9, the major cutting edge 8 can be accordingly secured for a longer edge length. Thus, the cutting insert 1 can be sufficiently increased in cutting performance.

Still further, the major cutting edge 8 extends so as to gradually incline toward a middle part of the side face of the insert in the insert axis direction O2 as being close to the connecting edge 11 on the opposite side of the minor cutting edge 9 adjacent to the major cutting edge 8. Thus, the following effects can be provided.

That is, when the cutting insert 1 is attached to the tool main body 31, it is possible to give a sufficient positive angle to an axial rake angle of the major cutting edge 8 of one cutting edge 5A used for cutting and also increase the sharpness. Further, the axial rake angle of the major cutting edge 8 can be increased to give a positive angle. Thus, in a posture in which the cutting insert 1 is attached to the tool main body 31, it is possible to increase an extent in which the insert axis O2 of the cutting insert 1 gradually inclines toward the end of the tool main body 31 as being close to the forward in the tool rotating direction T (that is, a displacement amount of the insert axis O2 per unit length pointed at the direction of the tool axis O1 along the tool rotating direction T).

Further, the minor cutting edge 9 extends so as to gradually incline toward a middle part of the side face of the insert along the insert axis direction O2 as being close to the connecting edge 11 on the opposite side of the major cutting edge 8 adjacent to the minor cutting edge 9. Therefore, the following effects can be provided.

That is, in FIG. 4, it is possible to decrease a difference in height (a difference along the insert axis direction O2) between (i) the minor cutting edge 9 which constitutes one cutting edge 5A used for cutting on machining and (ii) the connecting edge 11 which is a portion connected to the major cutting edge 8 (a cutting edge 5 not used for cutting) of the other cutting edge 5C positioned on the opposite side of the major cutting edge 8 of one cutting edge 5A adjacent to the minor cutting edge 9. Therefore, green compact press molding can be carried out easily in the manufacture of the cutting insert 1. Further, since the connecting edge 11 is decreased in difference in height, the major cutting edge 8 continuing to the connecting edge 11 can be secured for a longer edge length to sufficiently enhance the cutting performance.

Further, the side face 4 is provided with the second flank face 42 which is arranged on the opposite side of the cutting edge 5 of the first flank face 41 and in parallel with the insert axis O2. Therefore, the following effects can be provided.

That is, as described in the present embodiment, the second flank face 42 is arranged at the center part of the side face 4 of the insert main body 2 along the insert axis direction O2, by which the cutting insert 1 can be manufactured more easily.

Further, according to the indexable face milling cutter 30 of the present embodiment, the cutting insert 1 can be attached to the tool main body 31 in such a manner that a radial rake angle of the minor cutting edge 9 of one cutting edge 5A used for cutting forms a negative angle. Therefore, it is possible to disperse evenly cutting resistance acting on the minor cutting edge 9 in the edge length direction of the minor cutting edge 9 and sufficiently secure the edge strength. It is, thereby, possible to prevent edge fracture, and the like, for realizing a stable face milling operation and also extend the tool life of the cutting insert 1.

The present invention shall not be limited to the previously described embodiment and may be modified in various ways within a scope not departing from the gist of the present invention.

For example, in the previously described embodiment, the insert main body 2 of the cutting insert 1 is formed substantially in the shape of a square plate. Accordingly, the polygonal face 3 is formed substantially in the shape of a regular square (substantially square face) and four sets of cutting edges 5 are formed on the polygonal face 3. The present invention shall not be, however, limited thereto. That is, it is acceptable that the insert main body 2 of the cutting insert 1 is formed substantially in the shape of a regular polygonal plate and, accordingly, the polygonal face 3 is formed substantially in a regular polygonal shape which is rotational symmetry with respect to the insert axis O2 (substantially regular polygonal face). More specifically, it is acceptable that the insert main body 2 is formed, for example, in a shape of a regular triangular plate, a regular pentagonal plate, a regular hexagonal plate, a regular heptagonal plate and a regular octagonal plate, in addition to the previously described square plate. It is also acceptable that the polygonal face 3 is formed substantially, for example, in a regular triangular shape, in a regular pentagonal shape, in a regular hexagonal shape, in a regular heptagonal shape and in a regular octagonal shape, in addition to the previously described regular square shape. Further, the number of sets of cutting edges 5 formed on the polygonal face 3 may include, for example, three, five, six, seven and eight sets, in addition to the previously described four sets.

Still further, depending on the shape of the insert main body 2 and the shape of the polygonal face 3, there may be changed the numbers of side faced 4, ridge portions 12, seating portions 13 and breakers 14, whenever necessary.

Further, the shape and arrangement of each of the major cutting edge 8, the minor cutting edge 9, the connecting edge 11 and the corner edge 10 which constitute the cutting edge 5 of the cutting insert 1 are not limited to those of the previously described embodiment. Still further, the shape and arrangement of the breaker 14 are not limited to those of the previously described embodiment.

Further, the cutting insert 1 is attached in a detachable manner to the insert seat 32 of the tool main body 31 by using the clamp screw 20, to which the present invention shall not be, however, limited. It is acceptable that the cutting insert 1 is attached to the insert seat 32 in a detachable manner by using, for example, a wedge member other than the clamp screw 20.

Still further, the side face 4 is provided with the first flank face 41 which is arranged so as to be adjacent to the major cutting edge 8 and the corner edge 10 and the second flank face 42 which is arranged on the opposite side of the major cutting edge 8 and the corner edge 10 of the first flank face 41 and in parallel with the insert axis O2, to which the present invention shall not be, however, limited. In other words, it is acceptable that the first flank face 41 and the second flank face 42 are formed so as to correspond only to the major cutting edge 8. It is also acceptable that the second lank face 42 is not in parallel with the insert axis O2 and an inclination thereof with respect to the insert axis O2 is slower than the previously described inclination of the first flank face 41 (that is, smaller in inclination angle) which is formed in a shape of an inclined flat face. It is also acceptable that the second flank face 42 is formed on the side face 4.

Further, it is acceptable that the side face 4 has another flank face which is different in inclination from the flank faces 41 to 43, in addition to the first flank face 41 to the third flank face 43.

The present invention may be subjected to combination of various configurations (component features) described in the previously described embodiment, modified examples, and so on, in a scope not departing from the gist of the present invention and also subjected to addition of configurations, omission, replacement and other modifications. Further, the present invention shall not be restricted to the previously described embodiment but will be restricted only by the scope of the claims.

What is claimed is:

1. A cutting insert for a face milling cutter which is attached in a detachable manner to an insert seat formed on a tool main body of an indexable face milling cutter,
the cutting insert comprising:
an insert main body which is formed in a polygonal plate shape and in a shape of inversion symmetry on the front and back faces;
a pair of polygonal faces, each face of which is configured to be a seating face, which faces in a thickness direction of the insert main body and is seated on the insert seat, or a rake face which faces to the opposite side of the insert seat;
side faces which face in a direction intersecting with the thickness direction of the insert main body; and
cutting edges which are formed along an outer circumference of the polygonal face, and each of the cutting edges constituting a ridge line between the polygonal face and the side face,
wherein each of the polygonal faces is formed in a substantially regular polygonal shape which is rotational symmetry with respect to an insert axis passing through the center of the polygonal faces and extending in the thickness direction,
each of the cutting edges comprises;
a major cutting edge;
a minor cutting edge which extends from the major cutting edge so as to form an obtuse angle with respect to the major cutting edge when the polygonal face is seen in the front and is configured to improve a finishing face of a workpiece; and
a connecting edge which is positioned adjacent to the minor cutting edge so that the minor cutting edge is positioned between the major cutting edge and the connecting edge,
in each two adjacent cutting edges adjacent to each other along the outer circumference of the polygonal face, the connecting edge of one of the two adjacent cutting edges connects the minor cutting edge of the one of the two adjacent cutting edges to the major cutting edge of the other of the two adjacent cutting edges,
each of the side faces is provided with a first flank face which is arranged so as to be adjacent to the cutting edge and gradually inclines outward in an insert radial direction orthogonal to the insert axis as being spaced away from the cutting edge along a direction of the insert axis, and
the first flank face is arranged so as to be adjacent at least to the major cutting edge of the cutting edge.

2. The cutting insert for a face milling cutter according to claim 1, wherein
when the polygonal face is seen in the front, the connecting edge extends so as to run along an extension line of the minor cutting edge adjacent to the connecting edge.

3. The cutting insert for a face milling cutter according to claim 1, wherein
the major cutting edge extends so as to gradually incline toward a middle part of the side face of the insert along the insert axis direction as being close to the connecting edge on the opposite side of the minor cutting edge adjacent to the major cutting edge.

4. The cutting insert for a face milling cutter according to claim 2, wherein
the major cutting edge extends so as to gradually incline toward a middle part of the side face of the insert along the insert axis direction as being close to the connecting edge on the opposite side of the minor cutting edge adjacent to the major cutting edge.

5. The cutting insert for a face milling cutter according to claim 1, wherein
the minor cutting edge extends so as to gradually incline toward a middle part of the side face of the insert along the insert axis direction as being close to the connecting edge on the opposite side of the major cutting edge adjacent to the minor cutting edge.

6. The cutting insert for a face milling cutter according to claim 2, wherein
the minor cutting edge extends so as to gradually incline toward a middle part of the side face of the insert along the insert axis direction as being close to the connecting edge on the opposite side of the major cutting edge adjacent to the minor cutting edge.

7. The cutting insert for a face milling cutter according to claim 3, wherein
the minor cutting edge extends so as to gradually incline toward a middle part of the side face of the insert along the insert axis direction as being close to the connecting edge on the opposite side of the major cutting edge adjacent to the minor cutting edge.

8. The cutting insert for a face milling cutter according to claim 4, wherein
the minor cutting edge extends so as to gradually incline toward a middle part of the side face of the insert along the insert axis direction as being close to the connecting edge on the opposite side of the major cutting edge adjacent to the minor cutting edge.

9. The cutting insert for a face milling cutter according to claim 1, wherein
each of the side faces is provided with a second flank face which is arranged on the opposite side of the cutting edge of the first flank face and in parallel with the insert axis.

10. The cutting insert for a face milling cutter according to claim 2, wherein
each of the side faces is provided with a second flank face which is arranged on the opposite side of the cutting edge of the first flank face and in parallel with the insert axis.

11. The cutting insert for a face milling cutter according to claim 3, wherein
each of the side faces is provided with a second flank face which is arranged on the opposite side of the cutting edge of the first flank face and in parallel with the insert axis.

12. The cutting insert for a face milling cutter according to claim 4, wherein
each of the side faces is provided with a second flank face which is arranged on the opposite side of the cutting edge of the first flank face and in parallel with the insert axis.

13. The cutting insert for a face milling cutter according to claim 5, wherein
each of the side faces is provided with a second flank face which is arranged on the opposite side of the cutting edge of the first flank face and in parallel with the insert axis.

14. The cutting insert for a face milling cutter according to claim 6, wherein
each of the side faces is provided with a second flank face which is arranged on the opposite side of the cutting edge of the first flank face and in parallel with the insert axis.

15. The cutting insert for a face milling cutter according to claim 7, wherein
each of the side faces is provided with a second flank face which is arranged on the opposite side of the cutting edge of the first flank face and in parallel with the insert axis.

16. The cutting insert for a face milling cutter according to claim 8, wherein
each of the side faces is provided with a second flank face which is arranged on the opposite side of the cutting edge of the first flank face and in parallel with the insert axis.

17. An indexable face milling cutter comprising:
a tool main body which is formed in a disk shape and rotated around a tool axis in a tool rotating direction and in which insert seats are formed at an outer circumferential part of the end of the tool main body; and
the cutting insert for a face milling cutter according to claim 1 which is attached to the insert seat in a detachable manner,
wherein the minor cutting edge, which is arranged at the end of the cutting insert for a face milling cutter attached to the insert seat in the tool axis direction, gradually extends rearward in the tool rotating direction as being close to outward in the tool radial direction orthogonal to the tool axis.
